(19) United States
(12) Patent Application Publication
(10) Pub. No.: US 2010/0202626 A1
(43) Pub. Date: Aug. 12, 2010

(54) CONTROL DEVICE, CONTROL METHOD AND CONTROL PROGRAM

(75) Inventors: Yu SHIORI, Tokyo (JP); Kazuhiro Sekine, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/683,621

(22) Filed: Jan. 7, 2010

(30) Foreign Application Priority Data
Feb. 12, 2009 (JP) 2009-030113

(51) Int. Cl. H04R 1/10; H04R 3/00

(52) U.S. Cl. 381/74; 381/122

(57) ABSTRACT

A control device includes: a conversion unit converting an audio signal collected by a microphone into a pulse signal; a counting unit counting the number of generated pulses based on the pulse signal; a counting control unit controlling the counting unit so that pulses generated in a given period starting after one pulse has been generated in the pulse signal are excluded from counting targets of the number of generated pulses; and a control unit performing given control based on the number of generated pulses.

### BACKGROUND OF THE INVENTION

1. Field of the Invention

The present invention relates to a control device, a control method and a control program which is suitable for being applied, for example, when controlling a playback device by a user operation.

2. Description of the Related Art

When a user listens to music by a portable audio player, headphones are commonly used. In this case, starting and stopping of playing back music, fast-forwarding and rewinding of songs, increase and decrease of volume and so on are performed by, for example, operation buttons provided at the body of the audio player being operated by the user.

However, when the user put the audio player body in a bag or a pocket of clothes during listening to the music using headphones, to operate operation buttons of the audio player body will be burdensome for the user.

Considering the above, there exist headphones in which operation buttons of the audio player are provided at a casing of headphones.

There also exist headphones including microphones in casings of headphones, having a noise-cancelling function which allows the user to listen to audio with reduced ambient noise by outputting audio in opposite phase to the ambient noise collected by the microphones.

In related art, there are proposed headphones in which the number of tapping operations is determined by collecting sound generated by the tapping operation with respect to the casings by the user using the microphones for noise cancelling, and the audio player is controlled in accordance with the number of times (for example, refer to JP-A-2008-166897).

According to the headphones, it is possible to control the audio player by a simple operation of just tapping the casing without providing operation buttons additionally at the casing of the headphones. The tapping operation in this case indicates a user operation of tapping an object by a user's finger and the like once or plural times.

### SUMMARY OF THE INVENTION

In order to determine the number of tapping operations with respect to the casing in the above headphones, it is considered that sound generated by the tapping operation is collected by the microphone for noise cancelling and converted into a pulse signal, and the number of generated pulses can be determined as the number of tapping operations.

However, plural oscillations having close amplitude are actually generated in the sound generated by the tapping operation with respect to the casing in one tapping operation. Therefore, when the headphones convert the sound into the pulse signal, plural pulses may be generated from the pulse signal in one tapping operation.

Then, it is difficult that the headphones determine the number of tapping operations from the number of detected pulses accurately, therefore, the headphones wrongly recognize that there have been tapping operations different from the number of actual tapping operations, and perform control in accordance with an instruction different from an instruction intended by the user.

As described above, in the headphones of related art which perform control in accordance with the tapping operation, it was difficult to perform control accurately in accordance with the instruction desired by the user.

Thus, it is desirable to provide a control device, a control method and a control program capable of performing control accurately in accordance with an instruction desired by the user when performing control in accordance with sound generated by the user operation.

According to an embodiment of the invention, there is provided a control device including a conversion unit converting an audio signal collected by a microphone into a pulse signal, a counting unit counting the number of generated pulses based on the pulse signal, a counting control unit controlling the counting unit so that pulses generated in a given period starting after one pulse has been generated in the pulse signal are excluded from counting targets of the number of generated pulses and a control unit performing given control based on the number of generated pulses.

According to the above, when a user operation is performed through the microphone, the number of generated pulses corresponding to the number of user operations can be counted based on the pulse signal obtained by converting the collected audio signal and control can be performed in accordance with the number of times.

According to the embodiment of the invention, when a user operation is performed through a microphone, the number of generated pulses corresponding to the number of user operations can be counted based on the pulse signal obtained by converting the collected audio signal and control can be performed in accordance with the number of times. Therefore, it is possible to realize a control device, a control method and a control program capable of performing control accurately in accordance with an instruction desired by the user when performing control by sound generated by the user operation.

### BRIEF DESCRIPTION OF THE DRAWINGS

FIG. 1 is a block diagram showing a functional configuration of a control device to be an outline of an embodiment;

FIG. 2 is an outline view showing the entire configuration of a portable music playback device;

FIG. 3 is a block diagram showing a circuit configuration of the portable music playback device;

FIG. 4 is an outline view showing a waveform (1) of an audio signal at the time of tapping;

FIG. 5 is an outline view showing a waveform (1) of a pulse signal at the time of tapping;

FIG. 6 is an outline view showing a non-detection period;

FIG. 7A and FIG. 7B are outline views showing command correspondence tables;

FIG. 8 is a flowchart showing a command conversion processing procedure (1);

FIG. 9 is a flowchart showing a command conversion processing procedure (2);

FIG. 10 is an outline view showing a waveform (2) of an audio signal at the time of tapping;

FIG. 11 is an outline view showing a waveform (2) of a pulse signal at the time of tapping; and

FIG. 12 is an outline view showing a playback command correspondence table according to another embodiment.

### DESCRIPTION OF THE PREFERRED EMBODIMENTS

Hereinafter, the best mode for carrying out the invention (hereinafter, refer to embodiment) will be explained. The explanation will be made by the following order.

1. Embodiment

2. Other embodiments

### 1. Embodiment

### 1-1 Outline of the Embodiment

First, an outline of the embodiment will be explained. After the explanation of the outline, the embodiment will be explained.

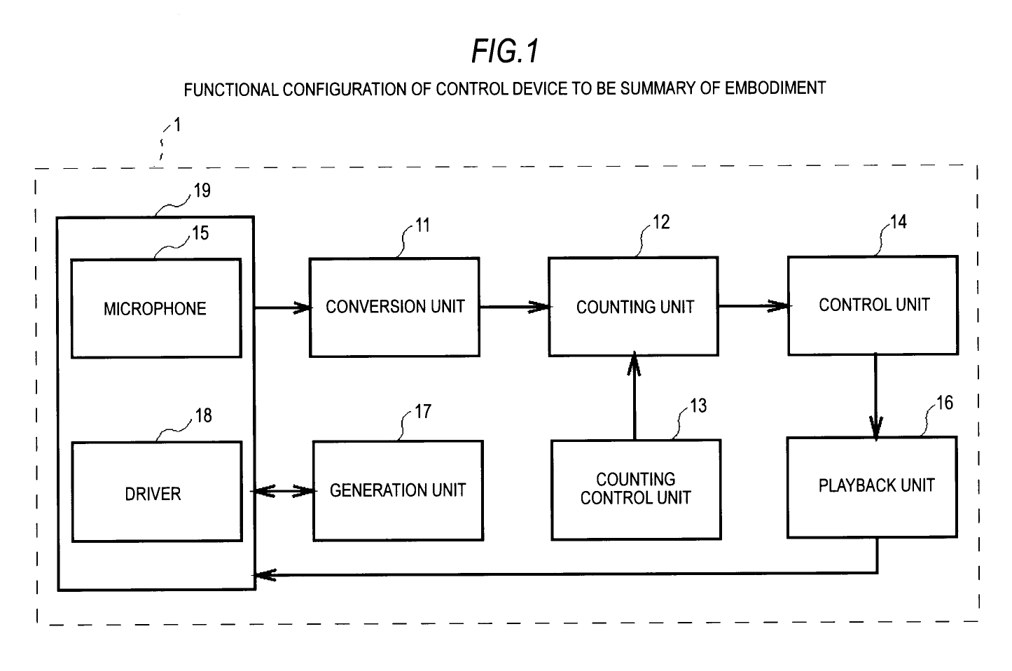

In FIG. 1, “1” denotes a functional configuration of a control device to be the outline of the invention. The control device 1 includes a conversion unit 11, a counting unit 12, a counting control unit 13 and a control unit 14.

The conversion unit 11 is configured to convert an audio signal collected by a microphone 15 into a pulse signal. The counting unit 12 is configured to count the number of detected pulses based on the pulse signal. The counting control unit 13 is configured to control the counting unit 12 so that pulses generated during a given period of time after one pulse is generated in the pulse signal are excluded from counting targets of the number of generated pulses. The control unit 14 is configured to perform given control based on the number of generation of pulses.

According to the above configuration, the control device 1 can count the number of generated pulses in accordance with the number of user operations based on the pulse signal obtained by converting the audio signal collected when the user operation is performed through the microphone 15, and also can perform control in accordance with the number of generated pulses.

Accordingly, the control device 1 can perform control accurately in accordance with an instruction desired by the user when performing control using sound generated by the user operation performed through the microphone 15.

It is preferable that a configuration of playing back content data is added to the control device 1 in addition to the above configuration.

In this case, the control device 1 includes a playback unit 16 in addition to the above respective units. The playback unit 16 is configured to play back content data. The control unit 14 is configured to control playback of the playback unit 16 based on the number of generated pulses counted by the counting unit 12.

In addition to the above configuration, it is also preferable that a function of cancelling noise is added to the control device 1.

In this case, the control device 1 includes a generation unit 17 in addition to the above respective units. The generation unit 17 is configured to generate a reduction signal for reducing an audio signal based on the audio signal of ambient noise (undesired sound) collected by the microphone 15.

In addition to the above configuration, it is also preferable that headphones 19 having two casings in which the microphone 15 and a driver 18 are respectively provided are added to the control device 1.

A specific example of the control device 1 having the above functional configuration will be explained in detail below.

### 1-2. Specific Example of the Embodiment

### 1-2-1. Entire Configuration of a Portable Music Playback Device

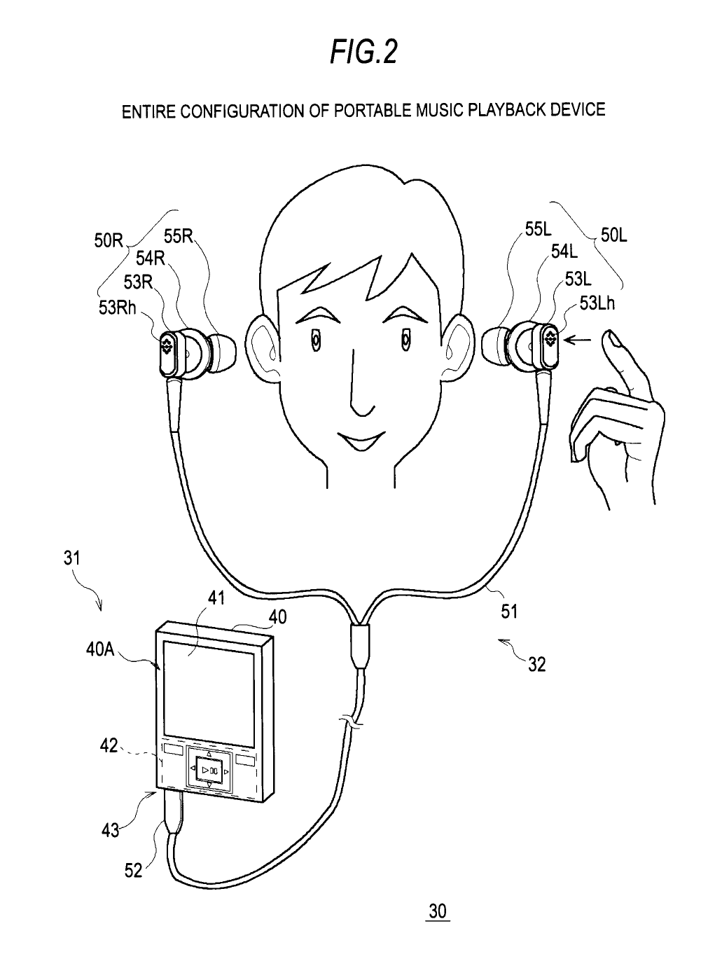

In FIG. 2, “30” denotes a portable music playback device which is a specific example of the above-described control device 1 as a whole, including a device body 31 and headphones 32. The headphones 32 are hardware corresponding to the headphones 19 of the above control device 1.

The device body 31 includes a flat casing 40 which has an approximately rectangular parallelepiped shape and the whole body is a size which can be held by a hand.

In the casing 40, a display unit 41 is provided in the center of a front surface 40A and an operation unit 42 having various operation buttons for starting and stopping playing back music, fast-forwarding and rewinding songs, increasing and decreasing volume and so on is provided in the lower part of the display unit 41. In addition, a jack 43 for connecting to the headphones 32 is provided at a lower left part of the casing 40.

The headphones 32 include a right speaker portion 50R for a right ear, a left speaker portion 50L for a left ear and a connection cable 51 for connecting the speaker portions to the device body 31. The right speaker portion 50R and the left speaker portion 50L are symmetrical. The connection cable 51 bifurcates into two cables at one end side, and the right speaker portion 50R is connected to one side thereof and the left speaker portion 50L is connected to the other side thereof. At the other end side of the connection cable 51, a plug 52 is provided.

The plug 52 of the connection cable 51 is inserted into the jack 43 of the device body 31, thereby connecting the headphones 32 to the device body 31 electrically.

The right speaker portion 50R of the headphones 32 includes a right-side casing 53R, a right-side driver unit 54R and a right-side earpiece 55R. On the other hand, the left speaker portion 50L also includes a left-side casing 53L, left-side driver unit 54L and a left-side earpiece 55L.

The right-side casing 53R is a casing having approximately elliptic cylindrical shape, which is directly connected to one end portion of end portions bifurcated at one end side of the connection cable 51. The left-side casing 53L is also a casing having the approximately elliptic cylindrical shape, which is directly connected to the other end portion of the portions bifurcated at one end side of the connection cable 51.

Further, the right-side driver unit 54R having an approximately disc shape is attached to the right-side casing 53R at an inner surface thereof, and the right-side earpiece 55R having an approximately an umbrella shape is attached to the right-side driver unit 54R so as to project into the opposite side of the right-side casing 53R.

On the other hand, the left-side driver unit 54L having the approximately disc shape is also attached to the left-side casing 53L at the inner surface thereof, and the left-side earpiece 55L having the approximately umbrella shape is attached to the left-side driver unit 54L so as to project into the opposite side of the left-side casing 53L.

The right-side earpiece 55R and the left-side earpiece 55L are inserted into the right and left lugholes of the user respectively.

In the portable music playback device 30, an audio signal is inputted to the headphones 32 connected from the device body 31 through the plug 52. Then, the audio signal of a right channel is transmitted to the right-side driver unit 54R through the connection cable 51 and the right-side casing 53R, and the audio signal of a left channel is transmitted to the left-side driver unit 54L through the connection cable 51 and the left-side casing 53L.

The audio of the right channel is outputted from the right-side driver unit 54R based on the transmitted audio signal of the right channel, thereby allowing the user to listen to the audio of the right channel through the right-side earpiece 55R.

Similarly, the audio of the left channel is outputted from the left-side driver unit 54L based on the audio signal of the transmitted left channel, thereby allowing the user to listen to the audio of the left channel through the left-side earpiece 55L.

The right-side casing 53R includes a right-side microphone 56R for noise cancelling. At an outer surface of the right-side casing 53R, a right-side microphone hole 53Rh for collecting ambient noise by the right-side microphone 56R is provided. Similarly, the left-side casing 53L includes a left-side microphone 56L for noise cancelling. At an outer surface of the left-side casing 53L, a left-side microphone hole 53Lh for collecting ambient noise by the left-side microphone 56L is provided.

In the portable music playback device 30, when the right-side microphone 56R and the left-side microphone 56L collect ambient noise, the right-side driver unit 54R and the left-side driver unit 54L output audio which is in opposite phase to the noise. Accordingly, the portable music playback device 30 is configured to allow the user to listen to audio with reduced ambient noise.

Moreover, when the user performs a tapping operation on the right-side microphone hole 53Rh or the left-side microphone hole 53Lh, the portable music playback device 30 is configured to collect sound generated by the tapping operation by the right-side microphone 56R or the left-side microphone 56L. The portable music playback device 30 is also configured to convert the tapping operation by the user into various commands based on the sound collected by the right-side microphone 56R or the left-side microphone 56L. The details will be described later.

The right-side driver unit 54R and the left-side driver unit 54L are hardware corresponding to the above driver 18 of the control device 1. The right-side microphone 56R and the left-side microphone 56L are hardware corresponding to the microphone 15 of the control device 1.

### 1-2-2. Circuit Configuration of the Portable Music Play Back Device

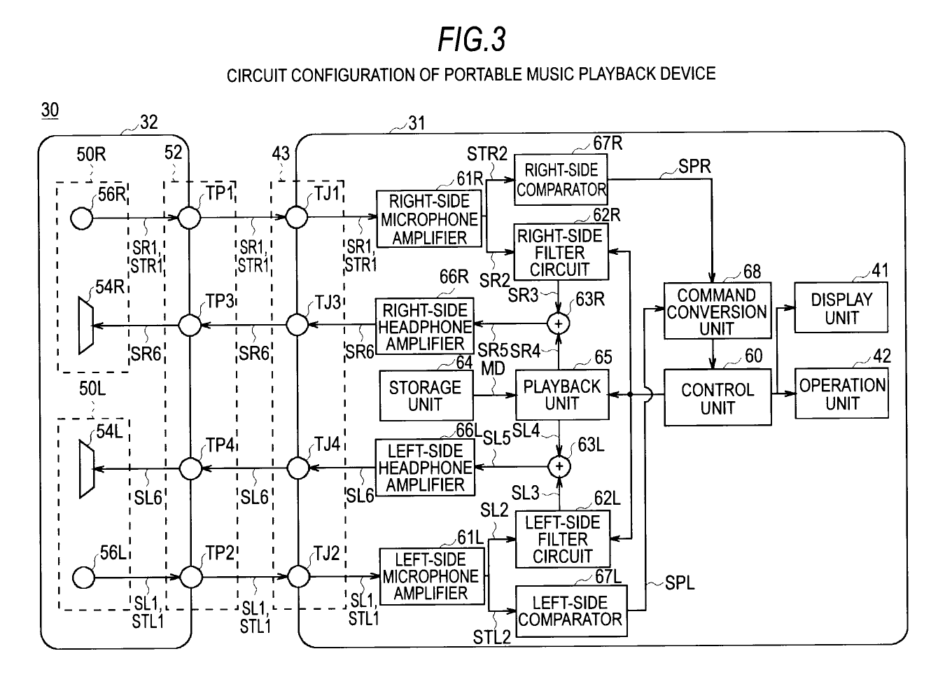

As shown in FIG. 3, in the portable music playback device 30, the plug 52 of the headphones 32 is electrically connected to the jack 43 of the device body 31.

Specifically, the headphones 32 are electrically connected to the device body 31 by connecting terminals TP1 to TP4 of the plug 52 and terminal TJ1 to TJ4 of the jack 43 which face each other.

Furthermore, in the portable music playback device 30, a control unit 60 included in the device body 31 is configured to perform overall control of the entire device in accordance with a program read from a not-shown ROM (Read Only Memory) as well as configured to execute various processing.

That is, the portable music playback device 30 plays back music data by the device body 31 under the control of the control unit 60 and outputs the played audio from the headphones 32, thereby allowing the user to listen to the played audio. At that time, the portable music playback device 30 collects ambient noise by the right-side microphone 56R and the left-side microphone 56L included in the right-side casing 53R and the left-side casing 53L (FIG. 2) and outputs the audio in opposite phase to the noise from the headphones 32. According to this, the portable music playback device 30 is configured to allow the user to listen to the played audio with reduced noise.

Specifically, the headphone 32 collect ambient noise by the right-side microphone 56R and transmit a right-side noise signal SR1 obtained as a result of collection to a right-side microphone amplifier 61R of the device body 31 through the terminal TP1 and the terminal TJ1.

Similarly, the headphones 32 collect ambient noise by the left-side microphone 56L and transmit a right-side noise signal SL1 obtained as a result of collection to a left-side microphone amplifier 61L of the device body 31 through the terminal TP2 and the terminal TJ2.

The right-side microphone amplifier 61R amplifies a signal level of the right-side noise signal SR1 transmitted from the right-side microphone 56R of the headphones 32 to a given level, and transmits a right-side amplified noise signal SR2 obtained as a result of amplification to a right-side filter circuit 62R.

Similarly, the left-side microphone amplifier 61L amplifies a signal level of the left-side noise signal SL1 transmitted from the left-side microphone 56L of the headphones 32 to a given level, and transmits a left-side amplified noise signal SL2 obtained as a result of amplification to a left-side filter circuit 62L.

The right-side filter circuit 62R inverts the phase of the right-side amplified noise signal SR2 to thereby generate a right-side noise reduction signal SR3 in opposite phase under control of the control unit 60, transmitting the signal SR3 to a right-side adder 63R.

Similarly, the left-side filter circuit 62L inverts the phase of the left-side amplified noise signal SL2 to thereby generate a left-side noise reduction signal SL3 in opposite phase under control of the control unit 60, transmitting the signal SL3 to a left-side adder 63L.

The control unit 60, when playback of music data is instructed by the user through the operation unit 42 provided at the device body 31, reads music data MD from a storage unit 64 in accordance with the instruction and transmits the data to a playback unit 65.

The playback unit 65 performs given playback processing such as decoding processing and D/A conversion processing to the music data MD, thereby obtaining a right-channel playback signal SR4 and a left-channel playback signal SL4. Then, the playback unit 65 transmits the right-channel playback signal SR4 to the right-side adder 63R and transmits the left-channel playback signal SL4 to the left-side adder 63L.

The right-side adder 63R generates a right-side synthetic signal SR5 by adding the right-side noise reduction signal SR3 transmitted from the right-side filter circuit 62R to the right-channel playback signal SR4 transmitted from the playback unit 65. Then, the right-side adder 63R transmits the right-side synthetic signal SR5 to a right-side headphone amplifier 66R.

Similarly, the left-side adder 63L generates a left-side synthetic signal SL5 by adding the left-side noise reduction signal SL3 transmitted from the left-side filter circuit 62L to the left-channel playback signal SL4 transmitted from the playback unit 65. Then, the left-side adder 63L transmits the left-side synthetic signal SL5 to a left-side headphone amplifier 66L.

The right-side headphone amplifier 66R amplifies a signal level of the right-side synthetic signal SR5 to a given level, and transmits a right-side channel signal SR6 obtained as a result of amplification to the right-side driver unit 54R of the headphone 32 through the terminal TJ3 and the terminal TP3.

Similarly, the left-side headphone amplifier 66L amplifies a signal level of the left-side synthetic signal SL5 to a given level, and transmits a left-side channel signal SL6 obtained as a result of amplification to the left-side driver unit 54L of the headphone 32 through the terminal TJ4 and the terminal TP4.

As a result, the right-side driver unit 54R outputs right-channel audio based on the right-channel signal SR6 and the left-side driver unit 54L left-channel audio based on the left-channel signal SL6.

As described above, the portable music playback device 30 plays back music data by the device body 31 and allows the user to listen to the played audio with reduced ambient noise from the headphones 32.

The playback device 65 is hardware corresponding to the playback unit 16 of the above control device 1. The right-side filter circuit 62R and the left-side filter circuit 62L are hardware corresponding to the generation unit 17 of the above control device 1.

Additionally, the control unit 60 of the device body 31 is configured to display various information, for example, information relating to music data such as title names and artist names of music data to be played back and information indicating present volume on the display unit 41.

Also, in the portable music playback device 30, when the user performs the tapping operation with respect to the right-side casing 53R or the left-side casing 53L of the headphone 32, commands for starting and stopping playing back music, fast-forwarding and rewinding songs, increasing and decreasing volume and so on can be inputted in accordance of the number of tapping operations.

Specifically, the right-side microphone 56R of the headphones 32 collects sound generated by the tapping operation in the right-side casing 53R and transmits a right-side audio signal STR1 obtained as a result of collection to the right-side microphone amplifier 61R of the device body 31 through the terminal TP1 and the terminal TJ1.

The right-side microphone amplifier 61R amplifies a signal level of the right-side audio signal STR1 transmitted from the right-side microphone 56R of the headphones 32 to a given level, and transmits a right-side amplified audio signal STR2 obtained as a result of amplification to a right-side comparator 67R.

The right-side comparator 67R, when the signal level of the right-side amplified audio signal STR2 exceeds a given threshold value, converts the signal to pulses and generates a right-side pulse signal SPR.

The right-side comparator 67R transmits the right-side pulse signal SPR to a command conversion unit 68 including a PIC (Peripheral Interface Controller) microcomputer.

Similarly, the left-side microphone 56L of the headphones 32 collects sound generated by the tapping operation in the left-side casing 53L and transmits a left-side audio signal STL1 obtained as a result of collection to the left-side microphone amplifier 61L of the device body 31 through the terminal TP2 and the terminal TJ2.

The left-side microphone amplifier 61L amplifies a signal level of the left-side audio signal STL1 transmitted from the left-side microphone 56L of the headphones 32 to a given level, and transmits a left-side amplified audio signal STL2 obtained as a result of amplification to a left-side comparator 67L.

The left-side comparator 67L, when the signal level of the left-side amplified audio signal STL2 exceeds a given threshold value, converts the signal to pulses and generates a left-side pulse signal SPL. Then, the left-side comparator 67L transmits the left-side pulse signal SPL to the command conversion unit 68.

The command conversion unit 68, when detecting pulses from the transmitted right-side pulse signal SPR or the left-side pulse signal SPL, recognizes that the tapping operation has performed to the right-side casing 53R or the left-side casing 53L by the user.

Then, the command conversion unit 68 counts the number of pulses detected in a given period (refer to a count period CT) by each count period CT. The count period CT is managed by a timer (not shown) in the command conversion unit 68, which is set continuously and repeatedly. The count period CT is set to 1(s).

Here, the number of times the command conversion unit 68 has detected pulses from the right-side pulse signal SPR during the count period CT is referred to as the number of right-side detected pulses, and the number of times the command conversion unit 68 has detected pulses from the left-side pulse signal SPL is referred to as the number of left-side detected pulses. The number of right-side detected pulses and the number of left-side detected pulses are also referred to as the number of detected pulses. The processing of counting the number of detected pulses by the command conversion unit 68 will be explained in detail later.

Then, the command conversion unit 68 determines the number of right-side detected pulses to be the number of times the tapping operation is performed to the right-side casing 53R by the user (referred to as the number of right-side tappings) during the count period CT. Also, the command conversion unit 68 determines the number of left-side detected pulses to be the number of times the tapping operation is performed to the left-side casing 53L by the user (referred to as the number of the left-side tappings) during the count period CT. The number of right-side tappings and the number of the left-side tappings are referred to as the number of tappings.

The command conversion unit 68 converts the tapping operation by the user into a command in accordance with the number of tappings, transmitting the command to the control unit 60. The processing in which the command conversion unit 68 converts the tapping operation by the user into a command in accordance with the number of tappings will be explained in detail later.

The control unit 60 controls respective units in accordance with commands transmitted from the command conversion unit 68 and executes various processing. For example, the control unit 60 controls the playback unit 65 to perform processing such as starting and stopping of playing back music, fast-forwarding and rewinding of songs, and further, controls the right-side headphone amplifier 66R and the left-side headphone amplifier 66L to execute processing of increasing and decreasing volume.

As described above, when the tapping operation is performed to the right-side casing 53R or the left-side casing 53L of the headphones 32 by user, the portable music playback device 30 converts the tapping operation by the user into commands and controls respective units in accordance with the commands.

The right-side comparator 67R and the left-side comparator 67L are hardware corresponding to the conversion unit 11 of the above control device 1. The command conversion unit 68 is hardware corresponding to the counting unit 12, the counting control unit 13 and the control unit 14 of the above control unit 1. Further, the control unit 60 is hardware corresponding to the control unit 14 of the above control device 1.

### 1-2-3. Processing of Counting the Number of Detected Pulses

Next, processing of counting the number of detected pluses by the above command conversion unit 68 will be explained in detail.

For example, assume that the tapping operation is performed to the right-side casing 53R twice during the count period CT by the user. At this time, sound generated by the tapping operation to the right-side casing 53R by the user is collected by the right-side microphone 56R and the right-side audio signal STR1 obtained as a result of the tapping operation is transmitted to the right-side comparator 67R as the right-side amplified audio signal STR2 through the right-side microphone amplifier 61R.

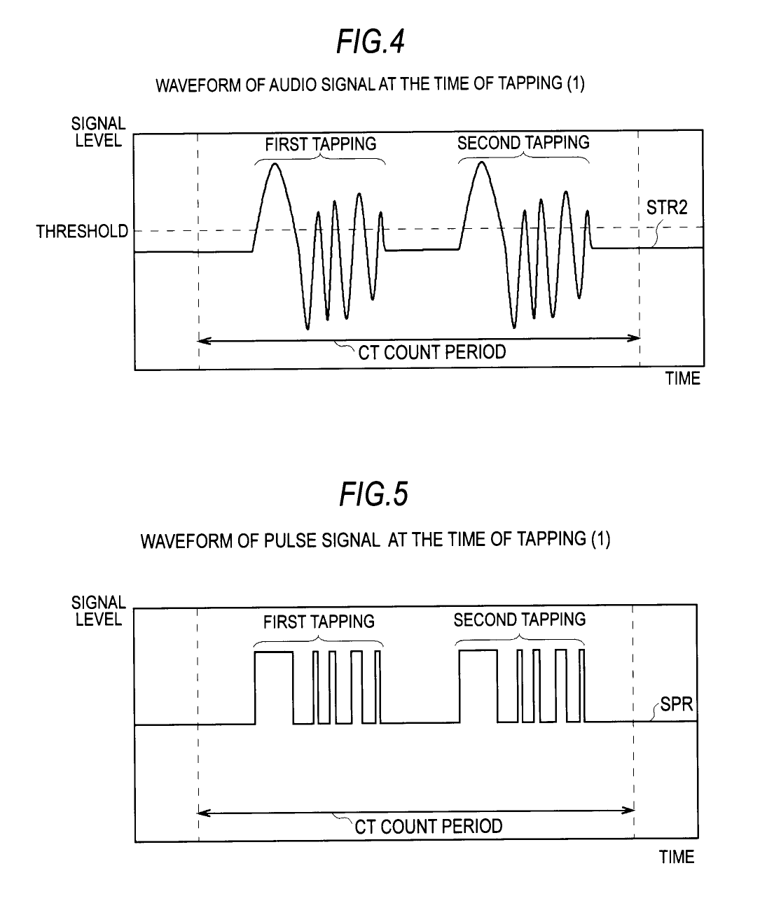

FIG. 4 shows an example of a waveform of the right-side amplified audio signal STR2 obtained at that time. As shown in FIG. 4, in the right-side amplified audio signal STR2, plural oscillations having close amplitude are generated in a signal level in each tapping operation.

Then, the right-side amplified audio signal STR2 is converted into pulses in a threshold of a given signal level (FIG. 4) by the right-side comparator 67R, and the right-side pulse signal SPR is generated.

FIG. 5 shows an example of a waveform of the right-side pulse signal SPR obtained based on the right-side amplified audio signal STR2. As shown in FIG. 5, in the right-side pulse signal SPR, five pulses are generated in one tapping operation and the total ten pulses are generated in two tapping operations.

Therefore, the command conversion unit 68 detects the total ten pulses in the two tapping operations when detecting all pulses generated in the right-side pulse signal SPR. Then, the command conversion unit 68 recognizes that the tapping operation has been performed to the right-side casing 53R when detecting pulses from the right-side pulse signal SPR, therefore, the command conversion unit 68 determines that the tapping operation has been performed ten times even though the tapping operation has been performed just twice.

As described above, the command conversion unit 68 may wrongly determine the number of right-side tappings when the command conversion unit 68 detects all pulses generated in each one tapping operation to the right-side casing 53R and determines the number of detected pulses to be the number of right-side tappings.

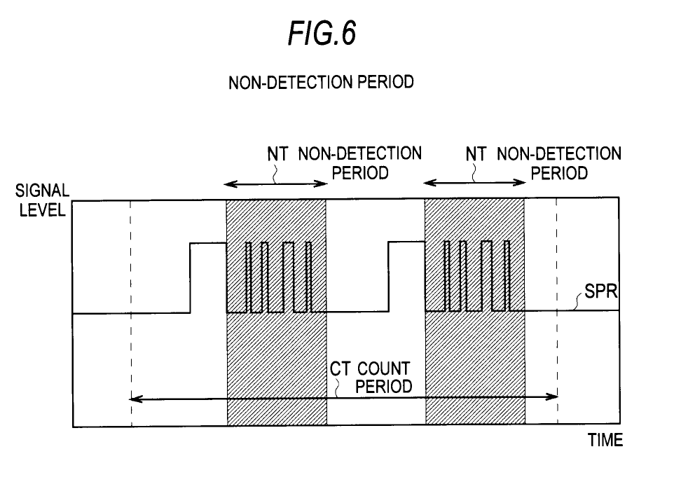

Accordingly, the command conversion unit 68 sets a non-detection period NT just after a pulse is detected from the right-side pulse signal SPR once and does not detect a pulse from the right-side pulse signal SPR during the non-detection period NT as shown in FIG. 6. That is, the command conversion unit 68 detects the falling edge of a head pulse of plural pulses which are continuously generated during a short period of time by one tapping operation by the user, starting the non-detection period NT from the falling edge of the head pulse.

When the tapping operation is continuously performed, the non-detection period NT is set to an adequate length (for example, 200 ms) so that pulses other than the head pulse in pulses generated by the first tapping operation are not detected but a pulse at the head of pulses generated by the second tapping operation is detected. Therefore, the non-detection period NT is set so as to be shorter than the count period CT. The non-detection period NT is managed by a timer in the command conversion unit 68.

The command conversion unit 68 can detect just one pulse from the right-side pulse signal SPR in each one tapping operation with respect to the right-side casing 53R by setting the above non-detection period NT, as a result, the number of right-side detected pulses can be counted as once. Accordingly, for example, in the case of FIG. 6, the command conversion unit 68 can count the number of right-side detected pulses as twice, therefore, the number of right-side detected pulses corresponds to the actual number of right-side tappings (twice).

As described above, the command conversion unit 68 can detect the number of pulses corresponding to the number of actual tapping operations to the right-side casing 53R and can determine the right-side tappings accurately from the number of right-side detected pulses.

In the same manner as in the above case of the right-side casing 53R, plural pulses may be generated in one tapping operation also when the left-side casing 53L is tapped. Therefore, the command conversion unit 68 may wrongly determine the number of left-side tappings when the command conversion unit 68 detects all pulses generated in each one tapping operation to the left-side casing 53L and determines the number of detected pulses to be the number of left-side tappings.

Accordingly, the command conversion unit 68 sets the non-detection period NT just after a pulse is detected from the left-side pulse signal SPL once, and does not detect a pulse from the left-side pulse signal SPL during the non-detection period NT.

Accordingly, the command conversion unit 68 can detect the number of pulses corresponding to the number of actual tapping operations with respect to the left-side casing 53L and can determine the left-side tappings from the left-side detected pulses accurately.

### 1-2-4. Command Conversion Processing

Next, processing of converting the tapping operation by the user into commands in accordance with the number of tappings by the above command conversion unit 68 will be explained in detail.

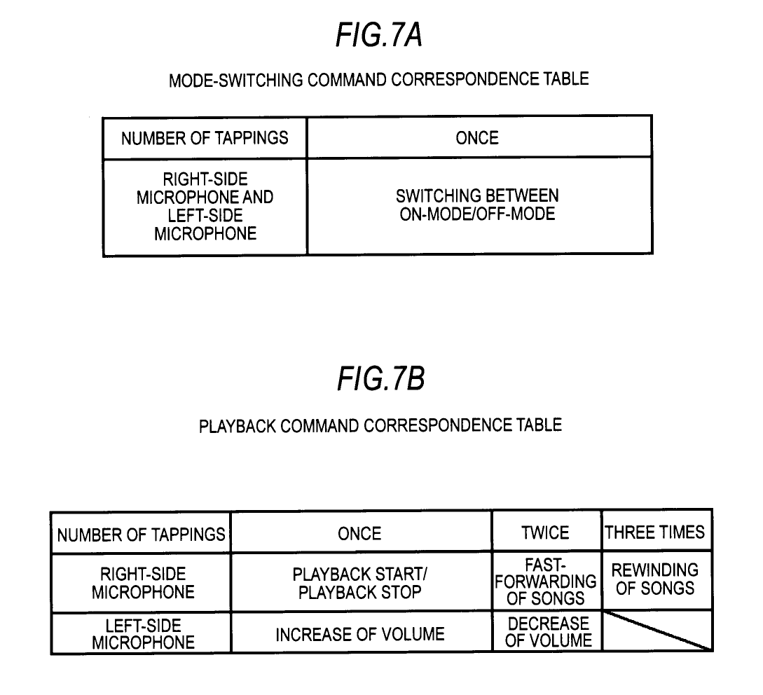

FIG. 7A and FIG. 7B show correspondence tables between the number of right-side tappings, the number of left-side tappings and commands to be converted. As shown in a mode-switching command correspondence table of FIG. 7A, the command conversion unit 68, when determining that each of the number of right-side tappings and the number of left-side tappings is once, converts the tapping operation by the user into a command of “switching between ON-mode/OFF-mode”. The command is also referred to as a mode-switching command.

ON-mode indicates a mode in which commands concerning playback of music for starting and stopping playing back music, fast-forwarding and rewinding songs, increasing and decreasing volume and so on (also referred to as playback commands) or the mode-switching command can be inputted by the tapping operation to the right-side casing 53R and the left-side casing 53L being performed by the user.

On the other hand, OFF-mode indicates a mode in which the mode-switching command can be inputted but the input of playback commands is prohibited by the tapping operation to the right-side casing 53R and the left-side casing 53L being performed by the user.

The portable music playback device 30 is configured to be operated in OFF-mode just after the power of the device body 31 is turned on.

Assume that, for example, the tapping operation is performed to each of the right-side casing 53R and the left-side casing 53L respectively once by the user during the count period CT in the OFF-mode.

At this time, the command conversion unit 68 determines that the number of right-side tappings and the number of left-side tappings to be once respectively and converts the tapping operation by the user into the mode-switching command of “switching between ON-mode/OFF-mode” in accordance with the mode-switching command correspondence table (FIG. 7A).

Then, the command conversion unit 68 is switched from OFF-mode to ON-mode in accordance with the mode-switching command.

In ON-mode, when the tapping operation is performed to the right-side casing 53R and the left-side casing 53L by the user, the portable music playback device 30 can input the playback commands for starting and stopping playing back music, fast-forwarding and rewinding songs, increasing and decreasing volume and so on in accordance with the number of tappings.

As shown in the playback command correspondence table of FIG. 7B, the command conversion unit 68 converts the tapping operation by the user into a playback command of “playback start/playback stop” when the number of right-side tappings is once in ON-mode. When the number of right-side tappings is twice, the tapping operation by the user is converted into a playback command of “fast-forwarding of songs”, and when the number of right-side tappings is three-times, the tapping operation by the user is converted into a playback command of “rewinding of songs”. Also in this case, the command conversion unit 68 converts the tapping operation by the user into a playback command of “increase of volume” when the number of left-side tappings is once, and the command conversion unit 68 converts the tapping operation by the user into a playback command of “decrease of volume” when the number of left-side tappings is twice.

Specifically, assume that, for example, the tapping operation to the right-side casing 53R is performed twice by the user during the count period CT in the ON mode.

At this time, the command conversion unit 68 determines that the number of right-side tappings is twice, and converts the tapping operation by the user into the playback command of “fast-forwarding of songs” in accordance with the playback command correspondence table (FIG. 7B).

Then, the command conversion unit 68 transmits the converted playback command of “fast-forwarding of songs” to the control unit 60.

The control unit 60 controls the playback unit 65 to play back a song next to the song which is played back now when music is played back now in accordance with the playback command of “fast-forwarding of songs” transmitted from the command conversion unit 68.

Assume that, for example, the tapping operation is performed to the left-side casing 53L once by the user in the count period CT in ON-mode.

At this time, the command conversion unit 68 determines that the number of left-side tappings is once, and converts the tapping operation by the user into a playback command of “increasing of volume” in accordance with the playback command correspondence table (FIG. 7B).

Then, the command conversion unit 68 transmits the converted playback command “increasing of volume” to the control unit 60.

The control unit 60 controls the right-side headphone amplifier 66R and the left-side headphone amplifier 66L to increase volume to be outputted from the right-side driver unit 54R and the left-side driver unit 54L in accordance with the playback command “increasing of volume” transmitted from the command conversion unit 68.

Assume that, for example, the tapping operation is performed to each of the right-side casing 53R and the left-side casing 53L respectively once by the user during the count period CT in ON-mode.

At this time, the command conversion unit 68 determines that the number of right-side tappings and the number of left-side tappings is once respectively and converts the tapping operation by the user into the mode-switching command of “switching between ON-mode/OFF-mode” in accordance with the mode-switching command correspondence table (FIG. 7A).

Then, the command conversion unit 68 is switched from OFF-mode to ON-mode in accordance with the mode-switching command.

In the OFF-mode, the command conversion unit 68 does not convert the tapping operation by the user into the playback command as described above even when the tapping operation is performed to the right-side casing 53R twice by the user during the count period CT.

As described above, the portable music playback device 30 sets the ON-mode and the OFF-mode, and does not convert the tapping operation by the user into the playback commands in OFF-mode, thereby preventing the playback commands from being inputted without user's intention.

As described above, when the tapping operation is performed to the right-side casing 53R or the left-side casing 53L, the portable music playback device 30 converts the tapping operation by the user (namely, user operation) into commands in accordance with the number of tappings and controls respective units in accordance with the commands.

### 1-2-5. Processing Procedure of Command Conversion

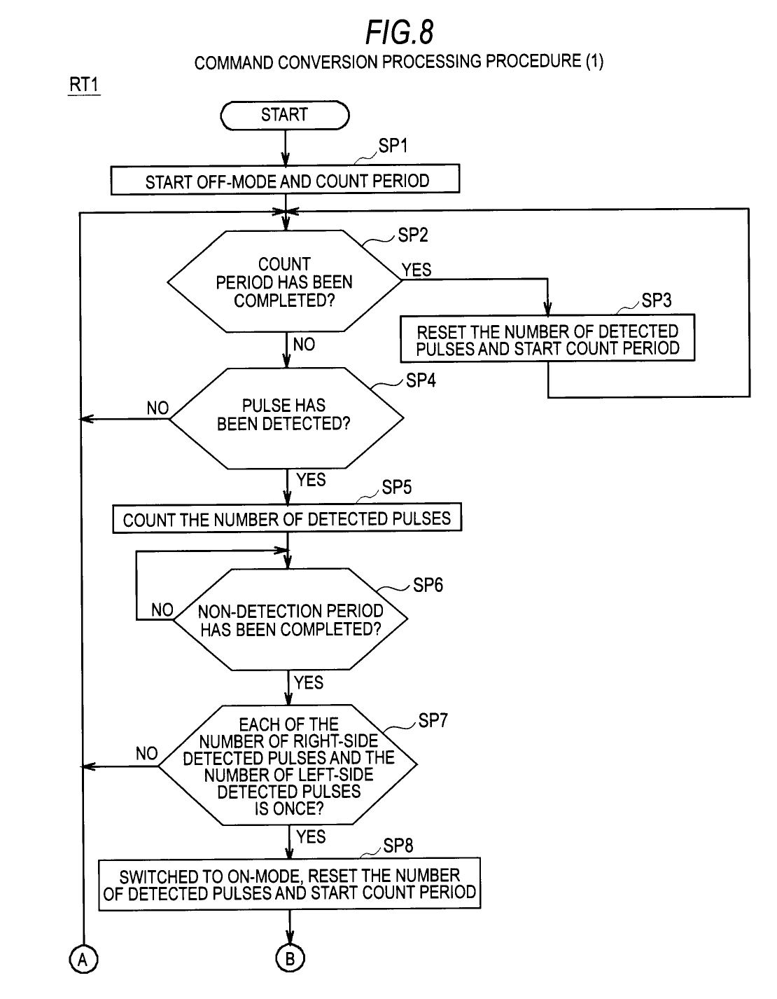

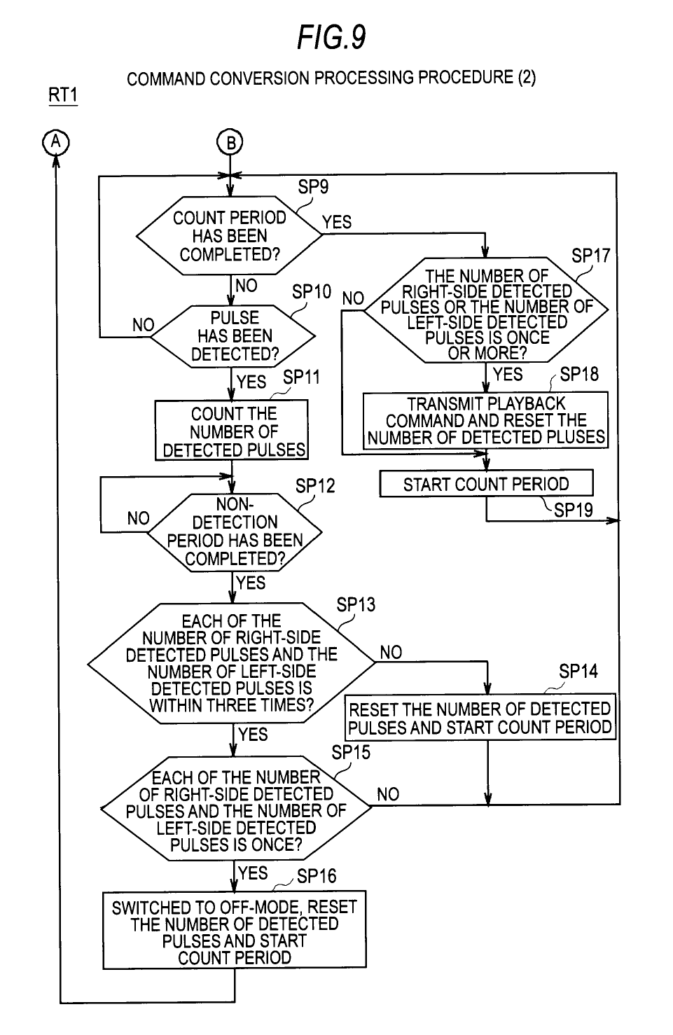

Next, a processing procedure in which the portable music playback device 30 converts the tapping operation by the user to the right-side casing 53R and the left-side casing 53L into commands in accordance with the number of tappings (referred to as a command conversion processing procedure RT1) will be explained with reference to flowcharts of FIG. 8 and FIG. 9. The command conversion processing procedure RT1 is a processing procedure executed by the command conversion unit 68 of the device body 31 in accordance with a program read from an internal memory (not shown) in the command conversion unit 68.

The command conversion unit 68 starts the command conversion processing procedure RT1 when, for example, the power of the device body 31 is turned on, then, proceeds to Step SP1.

In Step SP1, the command conversion unit 68 starts OFF-mode as well as starts the count period CT, then, proceeds to Step SP2.

In Step SP2, the command conversion unit 68 determines whether the count period CT has been completed or not.

Here, in the case that the count period CT has been completed and an affirmative result is obtained in Step SP2, which means that the mode-switching command has not been inputted by the tapping operation by the user during the count period CT. At this time, the command conversion unit 68 proceeds to Step SP3.

In Step SP3, the command conversion unit 68 resets the number of detected pulses, that is, sets the number of detected pulses to be “0” times for newly determining the number of tappings in a next period CT. Then, the command conversion unit 68 newly starts the count period CT and returns to Step SP2 to determine whether the count period CT has been completed or not again.

On the other hand, in the case that the count period CT has not been completed and a negative result is obtained in Step SP2, the command conversion unit 68 proceeds to Step SP4.

In Step SP4, the command conversion unit 68 determines whether a pulse has been detected from the right-side pulse signal SPR or the left-side pulse signal SPL or not.

In the case that the pulse has not been detected from the right-side pulse signal SPR and the left-side pulse signal SPL and a negative result is obtained in Step SP4, the command conversion unit 68 recognizes that the tapping operation has not been performed to the right-side casing 53R and the left-side casing 53L by the user. Then, the command conversion unit 68 returns to Step SP2 and determines whether the count period CT has been completed or not again.

On the other hand, in the case that the pulse has been detected from the right-side pulse signal SPR or the left-side pulse signal SPL and an affirmative result is obtained in Step SP4, the command conversion unit 68 recognizes that the tapping operation has been performed to the right-side casing 53R or the left-side casing 53L by the user. Then, the command conversion unit 68 proceeds to Step SP5.

In Step SP5, the command conversion unit 68 counts the number of right-side detected pulses when the pulse has been detected from the right-side pulse signal SPR and counts the number of left-side detected pulses when the pulse has been detected from the left-side pulse signal SPL. Then, the command conversion unit 68 proceeds to Step SP6.

In Step SP6, the command conversion unit 68 starts the non-detection period NT and waits for the completion of the non-detection period NT. When the non-detection period NT is completed, the command conversion unit 68 proceeds to Step SP7.

In Step SP7, the command conversion unit 68 determines whether each of the number of right-side detected pulses and the number of left-side detected pulses is once or not.

Here, in the case that each of the number of the number of right-side detected pulses and the number of left-side detected pulses is not once and a negative result is obtained in Step SP7, the command conversion unit 68 returns to Step SP2 and determines whether the count period CT has been completed or not again.

On the other hand, each of the number of right-side detected pulses and the number of left-side detected pulses is once and an affirmative result is obtained in Step SP7, the command conversion unit 68 determines that each of the number of right-side detected pulses and the number of left-side detected pulses is once and proceeds to Step SP8.

In Step SP8, each of the number of right-side detected pulses and the number of left-side detected pulses is once, therefore, the command conversion unit 68 converts the tapping operation by the user into the mode-switching command of “switching between ON-mode/OFF-mode” in accordance with the mode-switching command correspondence table (FIG. 7A).

Then, the command conversion unit 68 is switched from OFF-mode to ON-mode in accordance with the mode-switching command.

Moreover, the command conversion unit 68 resets the number of detected pulses and newly starts the count period CT, then, proceeds to Step SP9.

In Step SP9, the command conversion unit 68 determines whether the count period CT has been completed or not.

In the case that the count period CT has not been completed and a negative result is obtained in Step SP9, the command conversion unit 68 proceeds to Step SP10.

In Step SP10, the command conversion unit 68 determines whether a pulse is detected from the right-side pulse signal SPR or the left-side pulse signal SPL or not.

Here, in the case that the pulse has not been detected from the right-side pulse signal SPR or the left-side pulse signal SPL and a negative result is obtained in Step SP10, the command conversion unit 68 recognizes that the tapping operation has not been performed to the right-side casing 53R or the left-side casing 53L by the user. Then, the command conversion unit 68 returns to Step SP9 and determines whether the count period CT has been completed or not again.

On the other hand, in the case that the pulse has been detected from the right-side pulse signal SPR or the left-side pulse signal SPL and an affirmative result is obtained in Step SP10, the command conversion unit 68 recognizes that the tapping operation has been performed to the right-side casing 53R or the left-side casing 53L by the user. Then, the command conversion unit 68 proceeds to Step SP11.

In Step SP11, the command conversion unit 68 counts the number of right-side detected pulses when the pulse has been detected from the right-side pulse signal SPR and counts the number of left-side detected pulses when the pulse has been detected from the left-side pulse signal SPL. Then, the command conversion unit 68 proceeds to Step SP12.

In Step SP12, the command conversion unit 68 starts the non-detection period NT and waits for the completion of the non-detection period NT. When the non-detection period NT is completed, the command conversion unit 68 proceeds to Step SP13.

In Step SP13, the command conversion unit 68 determines whether each of the number of right-side detected pulses and the number of left-side detected pulses is within three times or not.

Here, in the case that each of the number of the number of right-side detected pulses and the number of left-side detected pulses is four or more times and a negative result is obtained in Step SP13, the command conversion unit 68 determines that the tapping operation by the user is invalid and proceeds to Step SP14.

Accordingly, the command conversion unit 68 can determine that the tapping operation by the user is invalid as a command earlier than the case in which whether the tapping operation by the user is valid is not determined until the count period CT is completed. Therefore, the conversion unit 68 can converts the tapping operation by the user into a command earlier when the command is inputted by the tapping operation being performed newly by the user with respect to the right-side casing 53R and the left-side casing 53L.

In Step SP14, the command conversion unit 68 resets the number of detected pulses, newly starts the count period CT and returns to Step SP9, in which whether the count period CT has been completed or not is determined again.

On the other hand, in the case that each of the number of right-side detected pulses or the number of left-side detected pulses is within three times and an affirmative result is obtained in Step SP13, the command conversion unit 68 proceeds to Step SP15.

In Step SP15, the command conversion unit 68 determines whether each of the number of right-side detected pulses and the number of left-side detected pulses is once or not.

Here, in the case that each of the number of the number of right-side detected pulses and the number of left-side detected pulses is not once and a negative result is obtained in Step SP15, the command conversion unit 68 returns to Step SP9 and determines whether the count period CT has been completed or not again.

On the other hand, each of the number of right-side detected pulses and the number of left-side detected pulses is once and an affirmative result is obtained in Step SP15, the command conversion unit 68 determines that each of the number of right-side detected pulses and the number of left-side detected pulses is once and proceeds to Step SP16.

In Step SP16, each of the number of right-side tappings and the number of left-side tappings is once, therefore, the command conversion unit 68 converts the tapping operation by the user into the mode-switching command of “switching between ON-mode/OFF-mode” in accordance with the mode-switching command correspondence table (FIG. 7A).

Then, the command conversion unit 68 is switched from ON-mode to OFF-mode in accordance with the mode-switching command.

Moreover, the command conversion unit 68 resets the number of detected pulses and newly starts the count period CT, then, proceeds to Step SP2.

On the other hand, in the case that the count period CT has been completed and an affirmative result is obtained in Step SP9, the command conversion unit 68 proceeds to Step SP17.

In Step SP17, the command conversion unit 68 determines whether each of the number of right-side detected pulses or the number of left-side detected pulses is one or more times or not.

Here, in the case that the number of right-side detected pulses or the number of left-side detected pulses is one or more times and an affirmative result is obtained in Step SP17, this means that the tapping operation has been performed to the right-side casing 53R or the left-side casing 53L by the user during the count period CT. At this time, the command conversion unit 68 proceeds to Step SP18.

In Step SP18, the command conversion unit 68 determines the number of right-side detected pulses to be the number of right-side tappings as well as determines the number of left-side detected pulses to be the number of left-side tappings. Then, the command conversion unit 68 converts the tapping by the user into a playback command in accordance with the playback command correspondence table (FIG. 7B) and transmits the playback command to the control unit 60.

The control unit 60 controls respective units in accordance with the playback command transmitted from the command conversion unit 68, executing various processing such as starting and stopping of playing back music, fast-forwarding and rewinding of songs, increasing and decreasing of volume.

Then, the command conversion unit 68 resets the number of detected pulses and proceeds to Step SP19.

On the other hand, in the case that each of the number of right-side detected pulses and the number of the left-side detected pulses is “0” times and a negative result is obtained in Step SP17, this means that the tapping operation has not been performed to the right-side casing 53R and the left-side casing 53L by the user during the count period CT. At this time, the command conversion unit 68 proceeds to Step SP19.

In Step SP19, the command conversion unit 68 newly starts the count period CT, returns to Step SP9 and determines whether the count period CT has been completed or not again.

The portable music playback device 30 converts the tapping operation by the user to the right-side casing 53R and the left-side casing 53L into commands in accordance with the number of tappings, following the above command conversion processing procedure RT1, and controls respective units in accordance with the commands.

### 1-2-6. Operations and Effects

In the above configuration, the portable music playback device 30 collects sound generated by the tapping operation performed to the right-side casing 53R by the user using the right-side microphone 56R. Then, the portable music playback device 30 transmits an audio signal obtained as a result of the collection to the right-side comparator 67R through the right-side microphone amplifier 61R of the device body 31.

The portable music playback device 30 also collects sound generated by the tapping operation performed to the left-side casing 53L by the user using the left-side microphone 56L. Then, the portable music playback device 30 transmits an audio signal obtained as a result of the collection to the left-side comparator 67L through the left-side microphone amplifier 61L.

The right-side comparator 67R converts the audio signal transmitted from the right-side microphone amplifier 61R into the right-side pulse signal SPR, and transmits the right-side pulse signal SPR to the command conversion unit 68. Similarly, the left-side comparator 67L converts the audio signal transmitted from the left-side microphone amplifier 61L into the left-side pulse signal SPL and transmits the left-side pulse signal SPL to the command conversion unit 68.

The command conversion unit 68 detects pulses generated in the right-side pulse signal SPR and counts the number of generated pulses. The command conversion unit 68 does not detect pulses generated in the non-detection period NT which is a given period started just after the pulse has been generated in the right-side pulse signal SPR. That is, the command conversion unit 68 excludes pulses generated during the given period which starts after the pulse has been generated in the right-side pulse signal SPR from counting targets of the number of detected pulses.

Accordingly, the command conversion unit 68 can count the number of times the tapping operation is performed to the right-side casing 53R, namely, the number of generated pulses corresponding to the number of user operations performed through the right-side microphone 56R based on the right-side pulse signal SPR.

Similarly, the command conversion unit 68 detects pulses generated in the left-side pulse signal SPL and counts the number of generated pulses. The command conversion unit 68 does not detect pulses generated in the non-detection period NT which is a given period started just after the pulse has been generated in the left-side pulse signal SPL. That is, the command conversion unit 68 excludes pulses generated during the given period which starts after the pulse has been generated in the left-side pulse signal SPL from counting targets of the number of detected pulses.

Accordingly, the command conversion unit 68 can count the number of times the tapping operation has been performed to the left-side casing 53L, namely, the number of generated pulses corresponding to the number of user operations performed through the left-side microphone 56L based on the left-side pulse signal SPL.

The command conversion unit 68 counts the number of generated pulses from the right-sdie pulse signal SPR and the left-side signal SPL during the count period CT which is a given period longer than the non-detection period NT.

The command conversion unit 68 converts the user operation into a command based on the number of generated pulses counted from the right-side pulse signal SPR and the left-side pulse signal SPL and transmits the command to the control unit 60.

The control unit 60 controls respective units to execute various processing in accordance with the command transmitted from the command conversion unit 68. For example, the control unit 60 controls the playback unit 65 playing back music data in accordance with the command transmitted from the command conversion unit 68 to execute various processing such as starting and stopping of playing back music, fast-forwarding and rewinding of songs.

Accordingly, the portable music playback device 30 can count the number of generated pulses in accordance with the number of user operations performed through the right-side microphone 56R and the left-side microphone 56L, and can perform control in accordance with the number of times.

Accordingly, the portable music playback device 30 can perform control in accordance with an instruction desired by the user when performing control in accordance with sound generated by the user operation performed through the right-side microphone 56R and the left-side microphone 56L.

Moreover, the right-side microphone 56R and the left-side microphone 56L which are microphones for noise cancelling are also used as microphones for collecting sound generated by the user operation in the portable music playback device 30.

Accordingly, the portable music playback device 30 can realize the above functions and effects without changing the internal configuration of the headphones 32 from the internal configuration of the headphones with the noise cancelling function of related art.

Also according to the above configuration, it is not necessary that the headphones 32 in the portable music playback device 30 change the shape thereof as compared with the headphones with the noise cancelling function of related art, therefore, the user is allowed to use the headphones in almost the same manner as the headphones of related art.

Furthermore, the command conversion unit 68 converts the tapping operation into the mode-switching command for performing switching between ON-mode and OFF-mode when determining that the tapping operation has been performed to the right-side casing 53R and the left-side casing 53L respectively once. That is, the command conversion unit 68 converts the user operation into commands in accordance with combination of the number of user operations performed through the right-side microphone 56R and the number of user operations performed through the left-side microphone 56L, and the control unit 60 performs control based on the commands.

Accordingly, it is possible to perform control in accordance with various types of commands as compared with the case in which the user operation is converted into commands in accordance with only the number of user operations performed through the right-side microphone 56R or only the number of user operations performed through the left-side microphone 56L.

Furthermore, the command conversion unit 68 is switched from OFF-mode in which playback commands are not inputted to ON-mode in which playback commands are inputted when determining that the tapping operation is performed to the right-side casing 53R and the left-side casing 53L respectively once. That is, when the number of the determined user operations is a given number of times previously set, the command conversion unit 68 is switched from OFF-mode in which playback commands are not inputted to ON-mode in which playback commands are inputted.

Accordingly, it is possible to prevent that the playback commands are inputted to the portable music playback device 30 and the device is controlled based on the commands without user's intention.

According to the above configuration, the portable music playback device 30 converts an audio signal collected by the right-side microphone 56R and the left-side microphone 56L into a pulse signal and the number of generated pulses is counted based on the pulse signal. In addition, the portable music playback device 30 excludes pulses generated in the non-detection period NT which is a given period starting after one pulse has been generated in the pulse signal from the count targets of the number of generated pulses. The portable music playback device 30 performs given control based on the number of generated pulses counted from the pulse signal.

Accordingly, the portable music playback device 30 is capable of counting the number of generated pulses corresponding to the number of user operations based on the pulse signal obtained by converting the collected audio signal when the user operation is performed through the right-side microphone 56R and the left-side microphone 56L, and is capable of performing control in accordance with the number of times. In this manner, the portable music playback device 30 is capable of perform control accurately in accordance with an instruction desired by the user when performing control in accordance with sound generated by the user operation performed through the right-side microphone 56R and the left-side microphone 56L.

### 2. Other Embodiments

### 2-1. Another Embodiment 1

In the above embodiment, the portable music playback device 30 converts the tapping operation to the right-side microphone 56R and the left-side microphone 56L by the user into various commands in accordance with the number of tappings.

It is not limited to the above and the portable music playback device 30 may convert the tapping operation by the user into various commands in accordance with combination of strength of the tapping operation and the number of tappings.

Specifically, processing of determining the strength of the tapping operation to the right-side casing 53R and the left-side casing 53L will be explained. For example, assume that the tapping operation was performed to the right-side casing 53R strongly for the first time and weakly for the second time during the count period CT. At this time, sound generated by the tapping operation to the right-side casing 53R is collected by the right-side microphone 56R, and the right-side audio signal STR1 obtained as the result of the collection is transmitted to the right-side comparator 67R as a right-side amplified audio signal STR2 through the right-side microphone amplifier 61R.

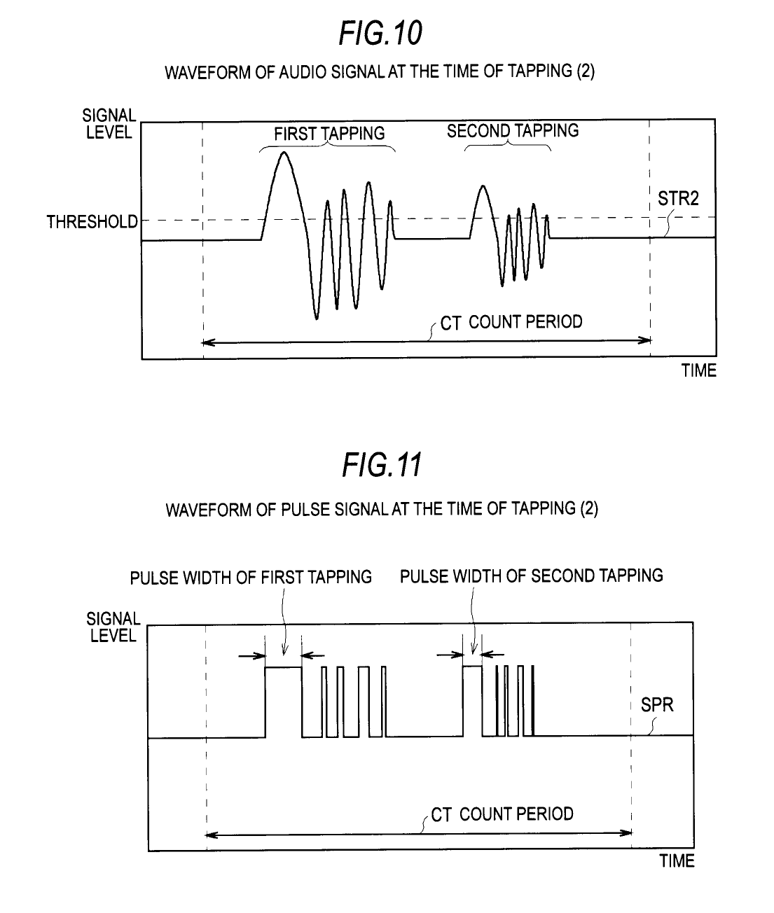

FIG. 10 shows an example of a waveform of the right-side amplified audio signal STR2 obtained in the above case. As shown in FIG. 10, since the first tapping operation is performed to the right-side casing 53R strongly, sound generated by the tapping operation is large, and oscillation with relatively large amplitude is generated in the right-side amplified audio signal STR2. On the other hand, since the second tapping operation was performed to the right-side casing 53R weakly, sound generated by the tapping operation is small, and oscillation with relatively small amplitude is generated in the right-side amplified audio signal STR2.

Then, the right-side amplified audio signal STR2 is converted into pulses in a threshold of a given signal level by the right-side comparator 67R and the right-side pulse signal SPR is generated.

FIG. 11 shows an example of a waveform of the right-side pulse signal SPR obtained based on the right-side amplified audio signal STR2 in this case. Since the oscillation with large amplitude has been generated in the right-side amplified audio signal STR2 in the first tapping operation, pulses having wide pulse width are generated in the right-side pulse signal SPR. On the other hand, oscillation with small amplitude has been generated in the right-side amplified audio signal STR2 in the second tapping operation, pulses having narrow pulse width are generated in the right-side pulse signal SPR.

Therefore, the command conversion unit 68 detects pulses having wide pulse width when the tapping operation is performed to the right-side casing 53R strongly and detects pulses having narrow pulse width when the tapping operation is performed to the right-side casing 53R weakly.

Therefore, the command conversion unit 68 detects the pulse width together when detecting pulses from the right-side pulse signal SPR, thereby determining the strength of the tapping operation to the right-side casing 53R.

Also in the tapping operation to the left-side casing 53L, the command conversion unit 68 detects the pulse width together when detecting pulses from the left-side pulse signal SPL, thereby determining the strength of the tapping operation to the left-side casing 53L in the same manner as described above.

Next, the processing of converting the tapping operation by the user into commands in accordance with combination of the number of tappings and the strength of the tapping operation will be specifically explained. The command conversion unit 68 counts the number of detected pulses as well as detects pulse widths thereof when detecting pulses from the right-side pulse signal SPR or the left-side pulse signal SPL.

Then, the command conversion unit 68 determines the number of detected pulses as the number of tappings as well as sorting the detected pulse widths into “strong” and “weak” based on a given threshold, thereby determining the strength of the tapping operation. The strength of the tapping operation can be determined in each one tapping operation or the strength of tapping operations may be determined as the whole in the case of continuous tapping operations. For example, the strength of the tapping operation can be determined based on the average pulse width of plural pulses detected by continuous tapping operations.

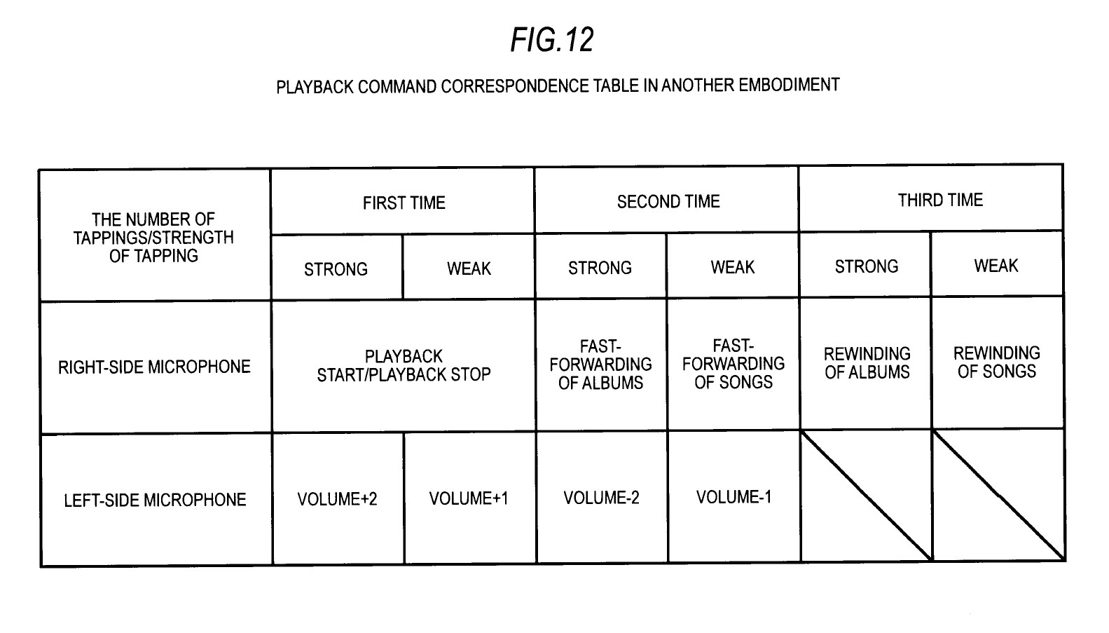

Then, the command conversion unit 68 converts the tapping operation by the user into playback commands in ON-mode in accordance with combination of the number of tappings and the strength of the tapping operation, for example, in accordance with the playback command correspondence table shown in FIG. 12.

As shown in FIG. 12, the command conversion unit 68 converts the tapping operation by the user into a playback command of “playback start/playback stop” when the number of right-side tappings is once in ON-mode regardless of the strength of tapping. When the number of right-side tappings is twice, the command conversion unit 68 converts the tapping operation by the user into a playback command of “fast-forwarding of albums” when the tapping operation is strong, and converts the tapping operation into a playback command of “fast-forwarding of songs” when the tapping operation is weak. Also in this case, when the number of right-side tappings is three-times, the tapping operation is converted into a playback command of “rewinding of albums” when the tapping is strong, and is converted into a playback command “rewinding of songs” when the tapping is weak.

When playback of music is performed, the playback command of “fast-forwarding of albums” is a playback command for performing playback of an album next to the album which is played back now. The playback command of “rewinding of albums” is a playback command for performing playback of an album before the album which is played back now when playback of music is performed.

When the number of left-side tappings is once in ON-mode, the command conversion unit 68 converts the tapping operation by the user into a playback command of “volume +2” when the tapping operation is strong, and converts the tapping operation into a playback command of “volume +1” when the tapping operation is weak. When the number of left-side tappings is twice, the command conversion unit 68 converts the tapping operation by the user into a playback command of “volume −2” when the tapping operation is strong, and converts the tapping operation into a playback command of “volume −1” when the tapping operation is weak.

The playback command “volume +2” is a playback command for setting a value of volume which is set now to a value of “+2”. Similarly, playback commands “volume +1”, “volume −2” and “volume −1” are playback commands for setting the value of volume which is set now to values of “+1”, “−2” and “−1”.

As described above, the tapping operation by the user is converted into commands in accordance with combination of the number of tappings and the strength of the tapping operation, thereby converting the tapping operation by the user into various types of commands as compared with the case in which the tapping operation by the user is converted into commands only in accordance with the number of tappings. Therefore, the control unit 60 can perform control in accordance with such various types of commands.

In this case, the tapping operation is converted into the playback commands in which the width of fast-forwarding and rewinding of songs as well as the width of increasing or decreasing of volume are large when the tapping operation is strong, whereas the tapping operation is converted into playback commands in which the width of fast-forwarding and rewinding of songs as well as the width of increasing or decreasing of volume are small when the tapping operation is weak.

Accordingly, it is possible to allow the user to easily recognize the relation between the tapping operation by the user and commands to be converted in accordance with the operation.

Furthermore, the command conversion unit 68 may convert the tapping operation by the user into various commands in accordance with various combination of the number of tappings and the strength of the tapping operation, not limited to the playback command correspondence table shown in FIG. 12.

### 2-2. Another Embodiment 2

In the above embodiments, the user inputs commands into the portable music playback device 30 by tapping the right-side casing 53R or the left-side casing 53L as the user operation.

It is also preferable that the user inputs commands into the portable music playback device 30 by rubbing the right-side casing 53R or the left-side casing 53L.

In this case, in the same manner as the case in which the right-side casing 53R or the left-side casing 53L is tapped by the user, the right-side microphone 56R or the left-side micropohone 56L collects sound generated by rubbing the right-side casing 53R or the left-side casing 53L by the user.

Then, the collected sound is converted into a pulse signal by the right-side comparator 67R or the left-side comparator 67L, and the command conversion unit 68 detects pulses from the pulse signal. At this time, the command conversion unit 68 provides the non-detection period NT after detecting the pulse from the pulse signal and does not detect pulses from the pulse signal during the non-detection period NT.

Then, the command conversion unit 68 determines that the number of pulses detected from the pulse signal to be the number of rubbings in the right-side casing 53R or the left-side casing 53L and converts the user operation into a command in accordance with the number of times.

Accordingly, the same effects as in the above case in which the right-side casing 53R or the left-side casing 53L is tapped can be realized also in the case in which the right-side casing 53R or the left-side casing 53L is rubbed by the user.

It is not limited to the above and it is also preferable that commands are inputted by various types of user operations as long as they are user operations in which the audio signal obtained by collecting sound generated by the user operation can be detected as pulses.

### 2-3. Another Embodiment 3

In the above embodiment, the command conversion unit 68 converts the tapping operation by the user into commands in accordance with the command correspondence tables (FIG. 7A and FIG. 7B). It is not limited to this and it is also preferable that the tapping operation by the user can be converted into various commands in accordance with various types of number of tappings.

For example, the command conversion unit 68 converts the tapping operation into a command for switching on/off of the noise cancelling function when the right-side casing 53R and the left-side casing 53L are tapped by the user respectively once.

It is not limited to the above and it is also preferable that the command conversion unit 68 converts the tapping operation by the user into the command for switching on/off of the noise cancelling function as well as converts the tapping operation by the user into the command of “switching between ON-mode/OFF-mode”.

At this time, for example, the portable music playback device 30 is configured to allow the noise cancelling function to be on when it is switched to ON-mode simultaneously as well as to allow the noise cancelling function to be off when it is switched to OFF-mode simultaneously in accordance with these commands.

It is not limited to the above and it is also preferable that the command conversion unit 68 converts the tapping operation by the user into the command of “switching between ON-mode/OFF-mode” as well as converts the tapping operation by the user into a command for switching on/off of a holding function of the operation unit 42 in the device body 31. The holding function of the operation unit 42 is a function of not inputting a command in ON-mode even when the operation unit 42 is operated.

At this time, for example, the portable music playback device 30 is configured to turn on the holding function when switching to ON-mode simultaneously as well as turn off the holding function when switching to OFF-mode simultaneously in accordance with the command. Accordingly, the portable music playback device 30 allows the user to input commands by performing the tapping operation to the right-side casing 53R and the left-side casing 53L in ON-mode, and allows the user to input commands by operating the operation unit 42 in OFF-mode.

### 2-4. Another Embodiment 4

In the above embodiment, the length of the non-detection period NT provided when the command conversion unit 68 detects pulses from the right-side signal SPR or the left-side pulse signal SPL is 200 ms.

It is not limited to this, and it is also preferable that the length can be variously set as long as it is the length in which pluses other than the head pulse in pulses generated in the first tapping operation are not detected but the head pulse generated by the second tapping operation is detected at the time of continuous tapping operations. For example, the length of the non-detection period NT may be set to approximately 100 ms to 300 ms.

### 2-5. Another Embodiment 5

In the above embodiment, the command conversion unit 68 determines the number of pulses detected during the count period CT in each count period CT which is continuously set to be the number of tapping operations by the user.

It is not limited to the above and it is also preferable that the command conversion unit 68 does not provide the count period CT, and determines the number of tapping operations by the user by determining that the tapping operation has been continuously performed when detecting a pulse in a given period after the non-detection period NT starting after the pulse has been detected.

### 2-6. Another Embodiment 6

In the above embodiment, when the command conversion unit 68 converts the tapping operation by the user into commands and the control unit 60 executes various processing in accordance with the commands, the execution of the command is not particularly notified to the user.

It is not limited to the above and it is preferable that, when the command conversion unit 68 converts the tapping operation by the user into commands and the control unit 60 executes various processing in accordance with the commands, the execution of the commands is notified by, for example, by voice.

Further, it is not limited to the above, and it is also preferable that the control unit 60 displays the present mode of ON-mode/OFF-mode on the display unit 41, and the display on the display unit 41 is switched when ON-mode/OFF-mode is switched in accordance with the tapping operation by the user.

### 2-7. Another Embodiment 7

Furthermore, in the above embodiment, the command conversion unit 68 starts the non-detection period NT from the falling edge of the pulse when the pulse is detected from the right-pulse signal SPR or the left-side pulse signal SPL.

It is not limited to the above and it is also preferable that the command conversion unit 68 starts the non-detection period NT from other various points as long as they are points where pulses other than the head pulse in pulses generated by one tapping operation are not detected. For example, the non-detection period NT may be started from the rising edge of the pulse.

### 2-8. Another Embodiment 8

Furthermore, in the above embodiment, the command conversion unit 68 starts the non-detection period NT when the pulse is detected from the right-pulse signal SPR or the left-side pulse signal SPL, and does not detect pulses in the non-detection period NT.

It is not limited to the above and it is also preferable that the command conversion unit 68 detects pulses from the right-pulse signal SPR or the left-side pulse signal SPL also in the non-detection period NT and excludes pulses detected in the non-detection period NT from counting targets of the number of generated pulses.

### 2-9. Another Embodiment 9

Furthermore, in the above embodiment and other embodiments 1 to 8, the portable music playback device 30 as the control device 1 is provided with the right-side comparator 67R and the left-side comparator 67L as the conversion unit 11. The portable music playback device 30 is also provided with the command conversion unit 68 as the counting unit 12, the counting control unit 13 and the control unit 14, and the control unit 60 as the control unit 14.

In addition, the portable music playback device 30 is provided with the playback unit 65 as the playback unit 16, and the right-side filter circuit 62R and the left-side filter circuit 62L as the generation unit 17. The portable music playback device 30 is also provided with the right-side driver unit 54R and the left-side driver unit 54L as the driver 18, and the headphones 32 as the headphones 19. The portable music playback device 30 is further provided with the right-side microphone 56R and the left-side microphone 56L as the microphone 15.

The invention is not limited to the above and it is also preferable that the above respective units of the portable music playback device 30 are configured by hardware or software if they have the same functions.

Additionally, the invention can be also applied to various types of control devices such as an IC recorder and a portable telephone device as long as they are control devices in which the audio signal is inputted from the microphone and control is performed in accordance with the audio signal, not limited to the portable music playback device 30.

### 2-10. Another Embodiment 10

Furthermore, the invention is not limited to the above embodiment and other embodiments 1 to 9. That is, the applicable scope of the invention extends to modes in which the above embodiment is optionally combined with part of or all of other embodiments 1 to 9, or modes in which part of the embodiments is extracted.

For example, another embodiment 1 may be combined with another embodiment 6. In this case, the portable music playback device 30 notifies the user of the command to be executed, thereby allowing the user to confirm the command even when the user forgets the command because there are many commands.

The invention can be widely used by, for example, a portable audio player having the noise cancelling function efficiently.

The present application contains subject matter related to that disclosed in Japanese Priority Patent Application JP 2009-030113 filed in the Japan Patent Office on Feb. 12, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A control device comprising:
a conversion unit converting an audio signal collected by a microphone into a pulse signal;
a counting unit counting the number of generated pulses based on the pulse signal;
a counting control unit controlling the counting unit so that pulses generated in a given period starting after one pulse has been generated in the pulse signal are excluded from counting targets of the number of generated pulses; and
a control unit performing given control based on the number of generated pulses.

2. The control device according to claim 1,
wherein the control unit performs given control based on the number of generated pulses counted during another given period.

3. The control device according to claim 2,
wherein the counting unit measures pulse widths of the generated pulses and
the control unit performs given control based on the number of generated pulses and the pulse widths.

4. The control device according to claim 2,
wherein the control unit activates a mode of performing the given control when the number of generated pulses is more than a given number of times.

5. The control device according to claim 2, further comprising:
a playback unit playing back content data,
wherein the given control is playback control of the playback unit.

6. The control device according to claim 5, further comprising:
a generation unit generating a reduction signal for reducing the audio signal based on the audio signal collected by the microphone.

7. The control device according to claim 6, further comprising:
headphones including two casings to which a driver and the microphone are provided respectively,
wherein the conversion unit converts audio signals collected by the two microphones provided at the two casings respectively into one pulse signal and the other pulse signal respectively,
the counting unit counts one number of generated pulses in one pulse signal and the other number of generated pulses in the other pulse signal based on one pulse signal and the other pulse signal, and
the control unit performs the given control based on one number of generated pulses and the other number of generated pulses.

8. A control method comprising the steps of:
converting an audio signal collected by a microphone into a pulse signal by a conversion unit;
counting the number of generated pulses based on the pulse signal by a counting unit;
controlling the counting unit by a counting control unit so that pulses generated in a given period starting after one pulse has been generated in the pulse signal are excluded from counting targets of the number of generated pulses; and
performing given control based on the number of generated pulses by a control unit.

9. A control program for allowing a computer to executes the steps of:
converting an audio signal collected by a microphone into a pulse signal by a conversion unit;
counting the number of generated pulses based on the pulse signal by a counting unit;
controlling the counting unit by a counting control unit so that pulses generated in a given period starting after one pulse has been generated in the pulse signal are excluded from counting targets of the number of generated pulse; and
performing given control based on the number of generated pulses by a control unit.
